(19) United States
(12) Patent Application Publication
(10) Pub. No.: US 2020/0340928 A1
(43) Pub. Date: Oct. 29, 2020

(54) Surface Coating Performance Assessment Systems and Methods

(71) Applicant: Lockheed Martin Corporation, Bethesda, MD (US)

(72) Inventors: Russell Guy Torti, Southlake, TX (US); William Betush, Weatherford, TX (US); James R. Reed, Azle, TX (US)

(21) Appl. No.: 16/397,336

(22) Filed: Apr. 29, 2019

(51) Int. Cl. G01N 21/88; G01N 21/64; B64F 5/60

(52) U.S. Cl. CPC G01N 21/88; G06F 3/0484; B64F 5/60; G01N 21/64

(57) ABSTRACT

A system includes an ultraviolet light source, a light-receiving apparatus, and a performance detector. The ultraviolet light source is configured to expose a surface to ultraviolet light. The surface includes a surface coating and a fluorescence layer beneath the surface coating. The light-receiving apparatus is configured to measure a fluorescence response to the ultraviolet light of the surface by detecting light in a predetermined frequency range within the visible light spectrum light. The performance detector is communicatively coupled to the light-receiving apparatus. The performance detector is configured to determine a proportion of the surface comprising the surface coating disposed over the fluorescence layer based on the measured fluorescence response. The performance detector is further configured to compare the determined proportion to a predetermined threshold.

### TECHNICAL FIELD

This disclosure relates in general to surface coatings, and more particularly to assessing the performance of surface coatings on vehicles or other apparatuses.

### BACKGROUND

Coatings of various types may be applied to surfaces of structures and vehicles to alter or enhance properties of the respective surface. For example, some coatings may be applied to provide a weather-resistant layer to protect the underlaying structure. As another example, a coating may be applied to reduce vibrations or other deleterious effects during operation of an aircraft.

These coatings may be maintained by inspecting the surfaces to determine whether the remaining coating is sufficient for its purposes or whether a reapplication of the coating is required. Large area surface coatings present a particularly difficult challenge, as it may be difficult to detect any defects in the coatings over a large surface area. Further, background illumination may interfere with inspecting whether the coating has been damaged or eroded.

### SUMMARY OF THE DISCLOSURE

According to one embodiment a method includes exposing a surface to ultraviolet light. The surface includes a surface coating and a fluorescence layer beneath the surface coating. The method further includes measuring a fluorescence response to the ultraviolet light at the surface by detecting light in a predetermined frequency range within the visible light spectrum. The method further includes determining a proportion of the surface comprising the surface coating disposed over the fluorescence layer based on the measured fluorescence response. The method further includes comparing the determined proportion to a predetermined threshold. The method further includes indicating a performance indicator of the surface based on the comparison.

In particular embodiments, the predetermined frequency range is based on fluorescence properties of the fluorescence layer of the surface.

In particular embodiments, the method further includes determining fluorescence properties of the surface.

In particular embodiments, if the determined proportion exceeds the predetermined threshold, providing the performance indicator includes indicating that the surface meets one or more performance criteria.

In particular embodiments, if the determined proportion does not exceed the predetermined threshold, indicating the performance indicator includes indicating that the surface does not meet one or more performance criteria.

In particular embodiments, the surface is a portion of an exterior of an aircraft.

In particular embodiments, the predetermined threshold is based on one or more of a type of the surface coating, a thickness of the surface coating, a location of the measured surface, a type of vehicle on which the surface resides, a type of the fluorescence layer, a type of a substrate on which the surface coating and fluorescence are disposed, and a type of application of the surface coating.

In particular embodiments, determining the proportion of the surface includes determining an area of the surface for which a fluorescence response is measured.

In particular embodiments, providing a performance indicator comprises providing first indication or a second indication to a user on a graphical user interface, wherein the first indication indicates that the surface meets one or more performance criteria and the second indication indicates that the surface does not meet one or more performance criteria.

In particular embodiments, providing a performance indicator includes providing a measurement based on the determined proportion to a user on a graphical user interface.

In particular embodiments, the method further includes selecting a surface type of the surface before measuring the fluorescence response. Determining a proportion of the surface including the surface coating disposed over the fluorescence layer is further based on the surface type.

In particular embodiments, the surface further includes a second surface coating and a second fluorescence layer beneath the second surface coating, wherein the second surface coating and the second fluorescence layer are disposed below the surface coating and the fluorescence layer. In some embodiments, the method further includes measuring a second fluorescence response to the ultraviolet light of the surface by detecting light in a second predetermined frequency range within the visible light spectrum. The method further includes determining a second proportion of the surface comprising the second surface coating disposed over the fluorescence layer based on the measured second fluorescence response. The method further includes comparing the determined second proportion to a second predetermined threshold. Providing a performance indicator of the surface is further based on the comparison of the determined second proportion to a second predetermined threshold.

According to another embodiment, a system includes a system includes an ultraviolet light source, a light-receiving apparatus, and a performance detector. The ultraviolet light source is configured to expose a surface to ultraviolet light. The surface includes a surface coating and a fluorescence layer beneath the surface coating. The light-receiving apparatus is configured to measure a fluorescence response to the ultraviolet light of the surface by detecting light in a predetermined frequency range within the visible light spectrum light. The performance detector is communicatively coupled to the light-receiving apparatus. The performance detector is configured to determine a proportion of the surface comprising the surface coating disposed over the fluorescence layer based on the measured fluorescence response. The performance detector is further configured to compare the determined proportion to a predetermined threshold.

In particular embodiments, the system further includes a graphical user interface. The graphical user interface is configured to provide a performance indicator of the surface based on the comparison. In some embodiments if the determined proportion exceeds the predetermined threshold, the graphical user interface is further configured to provide a graphical performance indicator indicating that the surface meets one or more performance criteria. In some embodiments, if the determined proportion does not exceed the predetermined threshold the graphical user interface is further configured to provide a graphical performance indicator indicating that the surface does not meet one or more performance criteria.

In particular embodiments, the predetermined frequency range is based on fluorescence properties of the fluorescence layer of the surface.

In particular embodiments, the performance detector is further configured to determine fluorescence properties of the surface.

According to yet another embodiment, a computer program product includes a non-transitory computer readable medium storing computer readable program code. The computer readable program includes program code for measuring a fluorescence response to ultraviolet light at a surface by detecting light in a predetermined frequency range within the visible light spectrum. The surface includes surface coating and a fluorescence layer beneath the surface coating. The computer readable program further includes program code for determining a proportion of the surface comprising the surface coating disposed over the fluorescence layer based on the measured fluorescence response. The computer readable program further includes program code for comparing the determined proportion to a predetermined threshold. The computer readable program further includes program code for providing a performance indicator of the surface based on the comparison.

The present disclosure may provide numerous technical advantages. For example, certain embodiments determine a surface coating performance indicator based on measuring a fluorescent response to incident ultra-violet light. Determining the performance indicator may include measuring a proportion of the surface covered by the surface coating based on the fluorescent response. In this manner, a large surface area may be inspected efficiently without interference of ambient light. As another example, certain embodiments measure a predetermined range of frequencies for the fluorescent response. As a result, irrelevant radiation may be ignored in determining the performance indicator. As yet another example, certain embodiments include a graphical user interface configured to provide the performance indicator. In this manner, an operator may quickly assess the status of the surface coating while performing the performance assessment.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1A illustrates an example vehicle onto which a surface coating is applied, according to certain embodiments;

FIG. 1B illustrates a cross-section of a surface of the vehicle in FIG. 1A, according to certain embodiments;

FIG. 2 illustrates a surface coating performance system, according to certain embodiments;

FIG. 3 illustrates a performance detector and graphical user interface of the surface coating performance system in FIG. 2, according to certain embodiments;

FIG. 4 is a flow chart diagram illustrating an example method of obtaining a surface coating performance indicator, according to certain embodiments.

### DETAILED DESCRIPTION OF THE DISCLOSURE

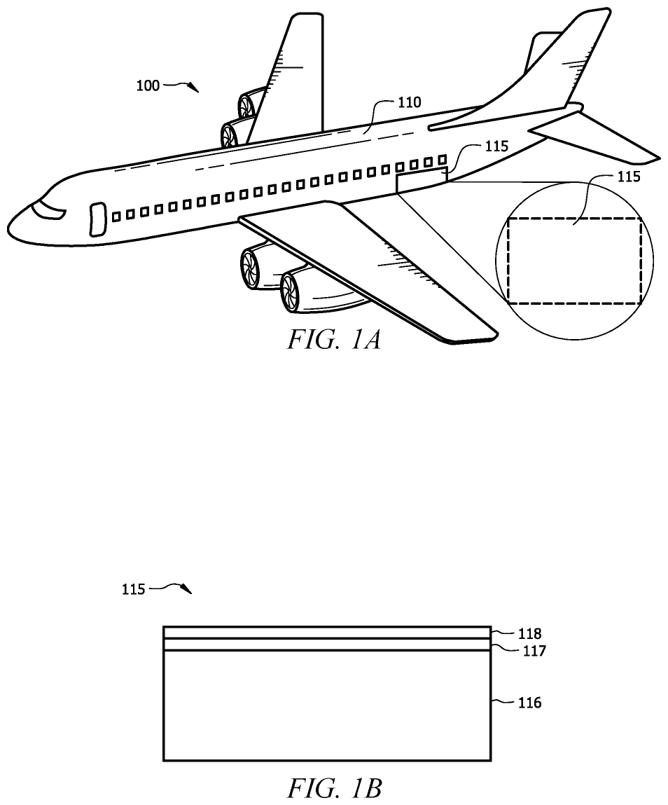

To facilitate a better understanding of the present disclosure, the following examples of certain embodiments are given. The following examples are not to be read to limit or define the scope of the disclosure. Embodiments of the present disclosure and its advantages are best understood by referring to FIGS. 1A through 4, where like numbers are used to indicate like and corresponding parts.

As described above, surface coatings may be maintained inspection to determine whether the remaining coating is sufficient for its purposes or whether a reapplication of the coating is required. Large area surface coatings present a particularly difficult challenge, as it may be difficult to detect any defects in the coatings over a large surface area. Further, background illumination may interfere with inspecting the coating. Described herein are various systems and methods that provide improved performance indication for large surface-area coatings using fluorescence.

The present disclosure may provide numerous technical advantages. For example, certain embodiments determine a surface coating performance indicator based on measuring a fluorescent response to incident ultra-violet light. Determining the performance indicator may include measuring a proportion of the surface covered by the surface coating based on the fluorescent response. In this manner, a large surface area may be inspected efficiently without interference of ambient light. As another example, certain embodiments measure a predetermined range of frequencies for the fluorescent response. As a result, irrelevant radiation may be ignored in determining the performance indicator. As yet another example, certain embodiments include a graphical user interface configured to provide the performance indicator. In this manner, an operator may quickly assess the status of the surface coating while performing the performance assessment.

Other technical advantages will be readily apparent to one skilled in the art from the following figures, descriptions, and claims. Moreover, while specific advantages have been enumerated above, various embodiments may include all, some, or none of the enumerated advantages.

FIG. 1A illustrates an example vehicle 100 having a surface 110. Surface 110 may include a portion 115 onto which a surface coating may be applied. For example, a surface coating may be applied to surface 110 to protect surface 110 and vehicle 100 from operational conditions and/or weather.

FIG. 1B a cross-section of portion 115 of surface 110 of vehicle 100. Portion 115 of surface 110 may include one or more layers. As shown in the illustrated example, subsection 115 of surface 110 may include substrate 116, fluorescent layer 117, and performance coating 118. In some embodiments, substrate 116 may be a base layer of coating applied to surface 110 or may be the outer layer of surface 110. For example, substrate 116 may be the outer metallic or ceramic skin of an aircraft. As another example, substrate 116 may be a coating layer applied to surface 110 prior to applying fluorescent layer 117 and performance coating 118.

In certain embodiments, fluorescent layer 117 may be applied on top of substrate 116. Fluorescent layer 117 may be configured to have a fluorescent response to incident radiation. For example, higher-energy radiation incident on fluorescent layer 117 may cause the excitation of fluorescent layer 117 and a subsequent relaxation, thereby causing an emission of lower energy radiation. In particular, ultra-violet radiation may be absorbed by fluorescent layer 117 and cause the emission of radiation in the visible or near-visible radiation spectrum.

In certain embodiments, fluorescent layer 117 may be configured to have additional functions beyond providing a fluorescence response to certain radiation. For example, fluorescent layer 117 may enhance the performance of surface 110. As specific examples, fluorescent layer 117 may decrease the weathering or erosion of surface 110, may increase thermal performance of surface 110, may reduce the radar signature of surface 110 and vehicle 110, etc.

In certain embodiments, performance coating 118 is applied on top of fluorescent layer 117. Performance coating 118 may enhance the operational performance of surface 110 of vehicle 110. For example, performance coating 118 may be a top coating applied to a car. The top coating may protect the underlying layers of paint and the body of the car from corrosion, e.g., due to water, chemical/light, or physical damage. For example, the top coating may repel stains from acid rain, bird droppings or pollen and/or prevent ice and snow adhesion in wintery conditions. In this manner performance coating 118 may protect surface 110 and provide additional benefits to vehicle 100.

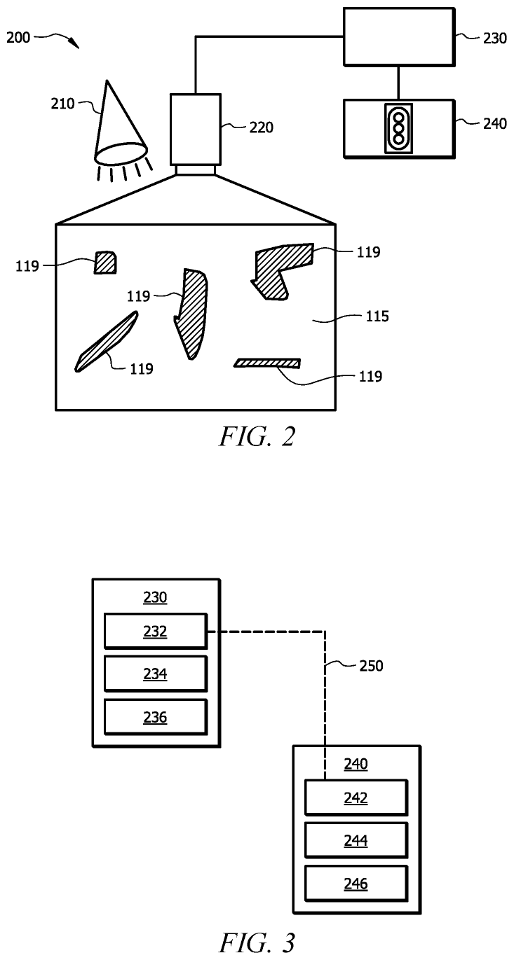

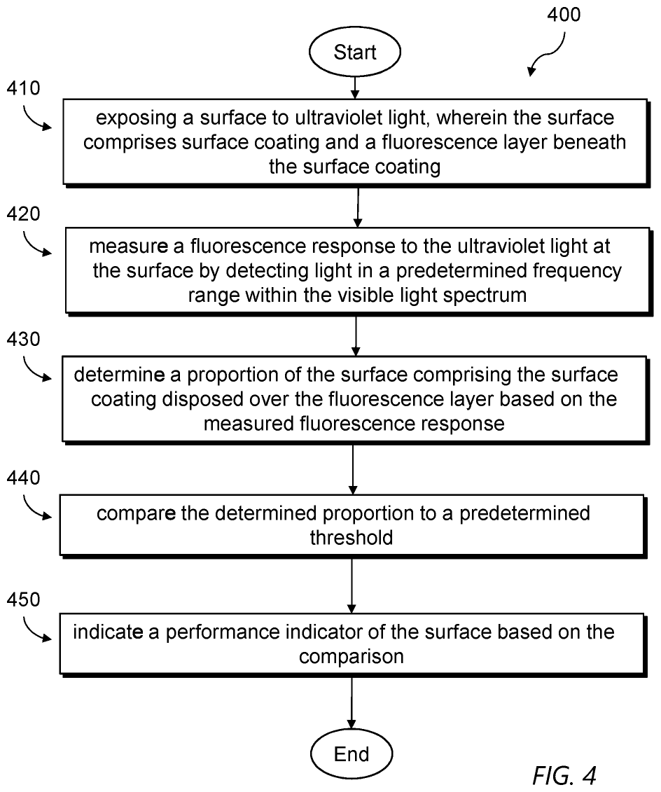

In certain embodiments, performance coating 118 does not emit radiation when exposed to high-energy radiation, such as ultraviolet radiation. For example, performance coating 117 may absorb incident ultra-violet radiation, thereby preventing the radiation from reaching fluorescent layer 117. Alternatively, performance coating 118 may not absorb all incident high-energy radiation but may block any resulting fluorescent response of fluorescent layer 117 from being emitted beyond surface 110. In either case, a fluorescent response may only be measured if at least a portion of performance coating 118 is removed from above fluorescent layer 117. In this manner, fluorescent layer 117 may be used to determine the presence and/or thickness of performance coating 118. Further embodiments describing examples using this process may be found below in reference to FIGS. 2 and 4.

In certain embodiments, portion 115 of surface 110 includes additional layers. For example, further performance coatings, in addition to performance coating 118, may be applied to surface 110. Different performance coatings 118 may have different functions that each enhance the operation of vehicle 100. In some embodiments, one or more additional fluorescent layers 117 may be disposed over surface 110. Each performance coating and fluorescent layer may be associated with one another. In this manner, depending on the fluorescent response, a performance indicator may be provided to indicated which, if any, of the performance coatings are damaged or otherwise need repair or maintenance.

In certain embodiments, different portions of surface 110 have applied different performance coatings and other layers. For example, certain portions of surface 110 may have more or fewer performance coatings 118 applied based on the location of that portion of surface 110 and/or the characteristics of the operational environment proximate that portion of surface 110. Accordingly, fluorescent layer 117 may be different based on the location of fluorescent layer 117 on surface 110. In this manner, different locations or applications may be configured to give different fluorescent responses.

While the example of vehicle 100 will be used throughout this disclosure as an example application of the methods and systems described herein, any suitable apparatus or structure onto which a surface coating may be applied is also contemplated in this disclosure. For example, vehicle 100 may be any type of vehicle, including an aircraft, a landcraft, a watercraft, a train, a hovercraft, and a helicopter. Further, certain embodiments may be applicable to surface coatings applied to stationary structures, such as buildings or other structures exposed to weather or other operational conditions.

In certain embodiments, performance coating 118 may erode or may be otherwise removed from surface 110. Using the example of vehicle 100 as an aircraft, incident particles may gradually wear away performance coating 118 during flight. Additionally, strikes by larger objects may cause scratches or gouges within performance coating 118. Once a certain amount of performance coating 118 is removed, the operational benefits of performance coating 118 may be compromised. Routine inspection is necessary to determine whether performance coating 118 meets certain predetermined specifications or if not, to repair portions of performance coating 118 to meet the specifications. As described before, inspecting large areas of surfaces, such as surface 110 of vehicle 100 can be time intensive and may be subject to interference by the environment, such as by ambient light in a visual inspection.

FIG. 2 illustrates a surface coating performance system (“SCPS”) 200, according to certain embodiments. In certain embodiments, SCPS 200 is configured to provide a performance indicator indicating whether performance coating 118 of a portion 115 of surface 110 meets predetermined standards. SCPS 200 may include ultra-violet light source 210, light-receiving apparatus 220, and performance detector 230.

In certain embodiments, ultra-violet light source 210 is configured to expose portion 115 of surface 110 to ultra-violet radiation. For example, ultra-violet light source 210 may be configured to expose the entirety of portion 115 of surface 110 with a significantly uniform amount of ultra-violet radiation. As described above, portion 115 of surface 100 includes a performance coating 118 over a fluorescent layer 117. Accordingly, any portion of portion 115 of surface 115 where performance coating is not present, e.g., due to erosion, scratching, or gouging, may exhibit a fluorescent response due to exposure of fluorescent layer 117 to ultra-violet radiation from ultra-violet light source 210. For example, exposed portions 119 of portion 115 of surface 110 may exhibit visible fluorescence.

In certain embodiments, light-receiving apparatus 220 may be any suitable light receiver or light detector in which incident radiation may be absorbed and/or detected. For example, light-receiving apparatus 220 may receiving and detect the fluorescence response to the incident ultra-violet radiation onto portion 115 of surface 110. Light-receiving apparatus 220 may be further configured to measure the fluorescence response by detecting light in a predetermined frequency range within the visible light spectrum. For example, light-receiving apparatus 220 may be configured to only measure light within the visible or near-visible light spectrum.

In some embodiments, light-receiving apparatus 220 is configured to only detect within a predetermined range of visible light. In this manner, the detection of the fluorescent response may be targeted based on an expected visible-light response. For example, SCPS 200 may obtain the characteristics of surface 110 being inspected, and based on those characteristics, configure light-receiving apparatus 220 to measure only within a predetermined range of frequencies. In some embodiments, light-receiving apparatus 220 may be configured to detect and/or measure within a frequency range beyond the predetermined frequency range. Light-receiving apparatus 220 may be configured to ignore or otherwise discard data corresponding to received light outside the predetermined frequency range. In some embodiments, light-receiving apparatus 220 communicates only information about received light within the predetermined frequency range to performance detector 230. Alternatively, light-receiving apparatus 220 communicates information across all frequencies for which light was detected, and performance detector 230 screens the information based on the predetermined frequency range. In either case, light that is irrelevant to the fluorescent response may be ignored, while the visible light response from fluorescent layer 117 is detected with higher accuracy.

In certain embodiments, performance detector 230 is communicatively coupled to light-receiving apparatus 220 such that information indicating the detection of light in the predetermined frequency range is received by performance detector 230 from light-receiving apparatus 220. Based on this received information and/or additional information regarding surface 110, performance detector 230 may indicate a performance indicator of portion 115 of surface 115.

In certain embodiments, performance detector 230 is configured to determine a proportion of portion 115 of surface 110 that is covered by performance coating 118. For example, based on the intensity of the received visible light at light-receiving apparatus 220 at a particular frequency or frequency range, performance detector 230 may determine what proportion of portion 115 of surface 110 is covered by performance coating 118. Performance detector 230 may obtain information regarding the size of portion 115 of surface 110. Performance detector 230 may also obtain information regarding the intensity of ultra-violet light incident on portion 115 of surface 110. Based on this information and the expected fluorescent response from fluorescent layer 117, performance detector 230 may determine what proportion of portion 115 has lost performance coating 118 or in another way, what proportion of performance coating 118 has been eroded or removed.

In certain embodiments, performance detector 230 may further compare the determined proportion to a predetermined threshold. For example, one or more predetermined thresholds may be associated with each inspected surface 110. The predetermined threshold may be obtained by performance detector based on a type of surface 110. The predetermined threshold may be stored as a ratio or percentage or any other suitable way to be compared to the determined proportion by performance detector 230. Based on the comparison, performance detector 230 may provide a performance indicator. The performance indicator may indicate whether portion 115 meets certain performance criteria. For example, if the fluorescent response is below a certain threshold, performance detector 230 may provide a “pass” indication that portion 115 of surface 110 meets performance criteria. Performance criteria may be specific to a particular surface type, application, or other criteria, as discussed below.

In certain embodiments, the predetermined threshold may be determined or based on one or more of a variety of factors related to the desired performance of the surface coating. In some embodiments, the predetermined threshold is based on one or more of a type of the surface coating, a thickness of the surface coating, a location of the measured surface, a type of vehicle on which the surface resides, a type of the fluorescence layer, a type of a substrate on which the surface coating and fluorescence are disposed, and a type of application of the surface coating. In this manner, the predetermined threshold may be based on the specific application for which performance coating 118 is used.

In certain embodiments, performance detector 230 is configured to determine the proportion of the surface by determining an area of portion 115 of surface 110 for which a fluorescence response is measured. For example, portion 115 of surface 110 may be broken up into pixels or subareas in which a binary yes/no determination may be made whether there is a fluorescent response within the pixel. These pixels may be sized according to desired accuracy and/or processing limitations of SCPS 200. Further, the pixel density may be based on other factors, such as the resolution of light-receiving apparatus 220. By determining the number of pixels exhibiting a fluorescent response and then dividing by the total amount of pixels, performance detector 230 may calculate a proportion of portion 115 of surface 110 that exhibits a fluorescent response. Based on this proportion, performance detector 230 may determine an area of portion 115 for which a fluorescent response is measured. This area can be compared against a maximum area to determine whether portion 115 of surface 110 meets performance criteria based on the amount of performance coating 118 remaining.

In certain embodiments, performance detector 230 is further configured to determine the fluorescence properties of surface 110. For example, performance detector 230 may obtain information regarding surface 110 to be inspected, including the characteristics of fluorescent layer 117. In this manner, performance detector 230 may obtain information indicating the frequency or frequency range in which a fluorescence response may occur. Accordingly, performance detector 230 may only consider relevant radiation from surface 110 in determining the performance indicator.

In certain embodiments, performance detector 230 provides a performance indicator indicating surface 110 meets one or more performance criteria based on whether the determined proportion exceeds the predetermined threshold. Alternatively, performance detector 230 provides a performance indicator indicating that surface 110 does not meet one or more performance criteria if the determined proportion does not exceed the predetermined threshold. For example, if the predetermined threshold for a surface coating of an aircraft is 0.1 (10%), then performance detector 230 may provide a “pass” performance indicator if it is determined that proportion of the surface of the aircraft retaining the surface coating is less than 0.1, e.g., 0.05. If, on the other hand, the aircraft retains only 85% of the surface coating, then performance detector 230 may indicate a “fail” performance indicator because 15% (0.15) of the surface exhibits a fluorescent response. While a pass/fail indication is the simplest type of performance indicator, SCPS 200 may provide a more detailed performance indicator, e.g., including the proportion of the area exhibiting the fluorescent response and/or other information associated with the surface.

In certain embodiments, surface 110 further includes a second performance coating and a second fluorescent layer beneath the second performance coating. In some embodiments, the second performance coating and the second fluorescent layer are disposed below performance coating 118 and the fluorescent layer 117.

In certain embodiments, a second fluorescence response to the ultraviolet light of the surface is measured by detecting light in a second predetermined frequency range within the visible light spectrum. For example, light-receiving apparatus 220 may receive light in from the second fluorescent layer in addition to light from fluorescent layer 117.

Additionally, performance detector 230 may determine a second proportion of surface 100 including the second performance coating disposed over the second fluorescent layer based on the measured second fluorescence response. For example, performance detector 230 may perform two measurements based on the different fluorescent signatures of the respective fluorescent layers. Specifically, performance detector 230 may make the determination of the first proportion first and the second proportion second, in a similar manner described above.

Further, performance indicator 230 may carry out a similar procedure for providing a performance indicator for the second performance coating by comparing the second proportion to the second predetermined threshold. The second predetermined threshold may be different from the predetermined threshold of the first performance coating 118. For example, the predetermined threshold may be different based on type of performance coating and/or any of the other factors described above.

In certain embodiments, SCPS 200 further includes graphical user interface 240. Graphical user interface 240 may provide an interface to an operator through which the performance criteria is communicated. For example, the performance indicator determined by performance detector 230 may be displayed by graphical user interface 240. As one example, graphical user interface 240 may provide a simple graphical display of performance indicator of a “pass” or “fail” status via a green or red stop light.

Graphical user interface 240 may be any suitable graphical user interface. For example, graphical user interface 240 may include one or more displays and/or operator inputs mechanisms. In this manner, graphical user interface 240 may display the performance indicator to the operator, e.g., during the inspection of surface 110.

In certain embodiments, graphical user interface 240 may also allow for operator input during the inspection of surface 110. The operator input may be communicated throughout SCPS 200 to enhance the determination of the performance indicator. For example, an operator may input information about surface 110 that is currently inspected and/or performance criteria. This may ensure that the correct information is used to determine the performance indicator for the inspected surface. For example, the inputted information may indicate what range of frequencies to look for a fluorescent response. Similarly, surface information may determine what predetermined threshold to apply in determining the performance indicator.

FIG. 3 illustrates performance detector 230 and graphical user interface 240 of SCPS 200, according to certain embodiments. Performance detector 230 may include one or more interfaces 232, memory 234, and processing circuitry 246. Graphical user interface 240 may include one or more interfaces 242, memory 234, and processing circuitry 246. Performance detector 230 and graphical user interface 240 may be communicatively coupled via a communication link 250. For example, data may be transferable from performance detector 230 to graphical user interface 240 via one of one or more interfaces 232, communication link 250 and one of one or more interfaces 242. In this manner, a determination of a performance indicator, or any intermediary thereof, may be communicated to graphical user interface 240 for display or indication to an operator through one of one or more interfaces 246.

Processing circuitry 232, 242 can be any electronic circuitry, including, but not limited to microprocessors, ASIC, ASIP, and/or state machines, that communicatively couples to one or more interfaces 232, 242, respectively, memory 234, 244, respectively. Processing circuitry 232, 242 may be 8-bit, 16-bit, 32-bit, 64-bit or of any other suitable architecture. Processing circuitry 232, 242 may include an ALU for performing arithmetic and logic operations, processor registers that supply operands to the ALU and store the results of ALU operations, and a control unit that fetches instructions from memory 234, 244, respectively, and executes them by directing the coordinated operations of the ALU, registers and other components. Processing circuitry 232, 242 may include other hardware and software that operates to control and process information. Processing circuitry 232, 242 executes software stored in memory 234, 244, respectively, to perform any of the functions of performance detector 230 and graphical user interface 240, respectively, described herein. Processing circuitry 232, 242 may control the operation of performance detector 230 and graphical user interface 240, respectively, for example by processing information received via one or more interfaces 236, 246 and/or memory 234, 244. Processing circuitry 232, 242 may be a programmable logic device, a microcontroller, a microprocessor, any suitable processing device, or any suitable combination of the preceding. Second processing circuitry 145 is not limited to a single processing device and may encompass multiple processing devices.

Memory 234, 244 may be any suitable type of memory. Memory 234, 244 may store, either permanently or temporarily, data, operational software, or other information for processing circuitry 232, 242, respectively. Memory 234, 244 may include any one or a combination of volatile or non-volatile local or remote devices suitable for storing information. For example, memory 234, 244 may include RAM, ROM, magnetic storage devices, optical storage devices, or any other suitable information storage device or a combination of these devices. The software represents any suitable set of instructions, logic, or code embodied in a computer-readable storage medium. For example, the software may be embodied in Memory 234, 244, a disk, a CD, or a flash drive. In particular embodiments, the software may include an application executable by processing circuitry 232, 242 to perform one or more of the functions of performance detector 230 and graphical user interface 240, respectively, described herein.

Memory 234, 244 may store one or more instructions or data, which when processed by processing circuitry 236, 246, cause performance detector 230 and graphical user interface 240, respectively, to perform any of the functions described in this disclosure. For example, memory 234 may store instructions of how to determine the proportion of portion 115 of surface 110 exhibits a fluorescent response indicating the lack of performance coating 118 based on information received from light-receiving apparatus 220. As another example, memory 246 may store instructions of what graphics to display based on the performance indicator determined by performance detector 230. Memory 234, 244 may further store information obtained about surface 110 and/or characteristics of performance coatings 118 and fluorescent layer 117 on which the performance indicators may be based.

FIG. 4 is a flow chart diagram illustrating an example method 400 of obtaining a surface coating performance indicator, according to certain embodiments. Method 400 may begin at step 410, at which a surface to be inspected is exposed to ultra-violet light. The surface inspected includes a surface coating and a fluorescence layer beneath the surface coating. For example, surface may include performance coating 118 and florescent layer 117 beneath performance coating 118.

Once exposed, at step 420, a fluorescence response to the ultra-violet light at the surface is measured by detecting light in a predetermined frequency range within the visible light spectrum. For example, a detector configured to measure within a range of frequencies may be used to detect light, including the amount of detected light, produced in response to the incident ultra-violet light.

Using the measured fluorescent response, at step 430, a proportion of the surface including the surface coating disposed over the fluorescence layer is determined based on the measured fluorescence response. For example, based on the amount of light received within the visible light spectrum, an area of the surface still covered by the surface coating may be determined. The proportion may be determined as a ratio or percentage of the inspected portion of the surface. At step 440, the determined proportion is compared to a predetermined threshold. The predetermined threshold may be based on a variety of factors, including the type of surface 110 and/or the type of performance coating 118. In some embodiments, the predetermined threshold and/or the predetermined frequency range is based on the fluorescence properties of the inspected surface. Prior to or concurrent to any of the other steps of method 400, the fluorescence properties of the surface may be determined. For example, the fluorescence properties may be retrieved from a data storage location, inputted by an operator, or based on real-time measurements.

At step 450, a performance indicator of the surface based on the comparison may be indicated. For example, in certain embodiments, the performance indicator may be indicated via a graphical user interface. In some embodiments, the performance indicator indicates whether the inspected surface meets one or more performance criteria associated with the inspected surface. For example, the performance criteria may be based on the type of surface and/or application. In some embodiments, the performance indicator may be one of two possible performance indicators. For example, the performance indicator may indicate a yes/no or pass/fail indication based on the condition of the surface. In some embodiments, the performance indicator is one indication along a scale, e.g., a gradient or a score out of 100.

Accordingly, method 400 provides a performance indicator of a surface coating at an inspected portion of a surface. In this manner, areas of surfaces, such as surfaces of aircraft or other vehicles, may be properly inspected efficiently and with high accuracy.

Modifications, additions, or omissions may be made to method 400 depicted in FIG. 4. Any steps may be performed in parallel or in any suitable order. For example, in certain embodiments, one or more steps of method 400 may be repeated for a different performance coating and/or separate fluorescent layer. Furthermore, method 400 may include more, fewer, or other steps. Additionally, one or more of the steps of method 400, or embodiments thereof, may be performed by any suitable component or combination of components of SCPS 200, ultraviolet light source 210, light-receiving apparatus 220, performance detector 230, and/or graphical user interface 240.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

The present disclosure may provide numerous advantages, such as the various technical advantages that have been described with respective to various embodiments and examples disclosed herein. Other technical advantages will be readily apparent to one skilled in the art from the following figures, descriptions, and claims. Moreover, while specific advantages have been enumerated in this disclosure, various embodiments may include all, some, or none of the enumerated advantages.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method, comprising:
exposing a surface to ultraviolet light, wherein the surface comprises a surface coating and a fluorescence layer beneath the surface coating;
measuring a fluorescence response to the ultraviolet light at the surface by detecting light in a predetermined frequency range within the visible light spectrum;
determining a proportion of the surface comprising the surface coating disposed over the fluorescence layer based on the measured fluorescence response;
comparing the determined proportion to a predetermined threshold; and
indicating a performance indicator of the surface based on the comparison.

2. The method of claim 1, wherein the predetermined frequency range is based on fluorescence properties of the fluorescence layer of the surface.

3. The method of claim 1, further comprising determining fluorescence properties of the surface.

4. The method of claim 1, wherein, if the determined proportion exceeds the predetermined threshold, providing the performance indicator comprises indicating that the surface meets one or more performance criteria.

5. The method of claim 1, wherein, if the determined proportion does not exceed the predetermined threshold, indicating the performance indicator comprises indicating that the surface does not meet one or more performance criteria.

6. The method of claim 1, wherein the surface is a portion of an exterior of an aircraft.

7. The method of claim 1, wherein the predetermined threshold is based on one or more of a type of the surface coating, a thickness of the surface coating, a location of the measured surface, a type of vehicle on which the surface resides, a type of the fluorescence layer, a type of a substrate on which the surface coating and fluorescence are disposed, and a type of application of the surface coating.

8. The method of claim 1, wherein determining the proportion of the surface comprises determining an area of the surface for which a fluorescence response is measured.

9. The method of claim 1, wherein providing a performance indicator comprises providing first indication or a second indication to a user on a graphical user interface, wherein the first indication indicates that the surface meets one or more performance criteria and the second indication indicates that the surface does not meet one or more performance criteria.

10. The method of claim 1, wherein providing a performance indicator comprises providing a measurement based on the determined proportion to a user on a graphical user interface.

11. The method of claim 1, further comprising selecting a surface type of the surface before measuring the fluorescence response, wherein determining a proportion of the surface comprising the surface coating disposed over the fluorescence layer is further based on the surface type.

12. The method of claim 1, wherein the surface further comprises a second surface coating and a second fluorescence layer beneath the second surface coating, wherein the second surface coating and the second fluorescence layer are disposed below the surface coating and the fluorescence layer.

13. The method of claim 12, further comprising:
measuring a second fluorescence response to the ultraviolet light of the surface by detecting light in a second predetermined frequency range within the visible light spectrum;
determining a second proportion of the surface comprising the second surface coating disposed over the fluorescence layer based on the measured second fluorescence response; and
comparing the determined second proportion to a second predetermined threshold;
wherein providing a performance indicator of the surface is further based on the comparison of the determined second proportion to a second predetermined threshold.

14. A computer program product comprising a non-transitory computer readable medium storing computer readable program code, the computer readable program comprising:
program code for measuring a fluorescence response to ultraviolet light at a surface by detecting light in a predetermined frequency range within the visible light spectrum, wherein the surface comprises a surface coating and a fluorescence layer beneath the surface coating;
program code for determining a proportion of the surface comprising the surface coating disposed over the fluorescence layer based on the measured fluorescence response;
program code for comparing the determined proportion to a predetermined threshold; and
program code for providing a performance indicator of the surface based on the comparison.

15. A system, comprising:
an ultraviolet light source configured to expose a surface to ultraviolet light, wherein the surface comprises a surface coating and a fluorescence layer beneath the surface coating;
a light-receiving apparatus, wherein the light-receiving apparatus is configured to measure a fluorescence response to the ultraviolet light of the surface by detecting light in a predetermined frequency range within the visible light spectrum light;
a performance detector communicatively coupled to the light-receiving apparatus, wherein the performance detector is configured to:
determine a proportion of the surface comprising the surface coating disposed over the fluorescence layer based on the measured fluorescence response; and
compare the determined proportion to a predetermined threshold.

16. The system of claim 15, further comprising a graphical user interface, wherein the graphical user interface is configured to provide a performance indicator of the surface based on the comparison.

17. The system of claim 16, wherein, if the determined proportion exceeds the predetermined threshold, the graphical user interface is further configured to provide a graphical performance indicator indicating that the surface meets one or more performance criteria.

18. The system of claim 16, wherein, if the determined proportion does not exceed the predetermined threshold the graphical user interface is further configured to provide a graphical performance indicator indicating that the surface does not meet one or more performance criteria.

19. The system of claim 15, wherein the predetermined frequency range is based on fluorescence properties of the fluorescence layer of the surface.

20. The system of claim 15, wherein the performance detector is further configured to determine fluorescence properties of the surface.
